(19) United States
(12) Patent Application Publication
(10) Pub. No.: US 2023/0238187 A1
(43) Pub. Date: Jul. 27, 2023

(54) DYE-SENSITIZED SOLAR CELL THAT GENERATES AND STORES ENERGY

(71) Applicant: Claire Marie Huang, Jacksonville, FL (US)

(72) Inventor: Claire Marie Huang, Jacksonville, FL (US)

(21) Appl. No.: 18/156,520

(22) Filed: Jan. 19, 2023

Related U.S. Application Data
(60) Provisional application No. 63/301,820, filed on Jan. 21, 2022.

(51) Int. Cl. H01G 9/20; H01G 9/00

(52) U.S. Cl. CPC H01G 9/2031; H01G 9/0029; H01G 9/2022; H01G 9/2004; H01G 9/2059

(57) ABSTRACT

A method of fabricating a photovoltaic absorber layer is provided. The method embodies the application of an anodic paste along the surface of the transparent conductive substrate, wherein the applied surface is coupled to a cathodic element forming a solar cell. The anodic paste comprises titanium dioxide nanoparticles in powder form mixed with light-absorbing dye and electrolytic paste.

### CROSS-REFERENCE TO RELATED APPLICATION

This application claims the benefit of priority of U.S. provisional application No. 63/301,820, filed 21 Jan. 2022, the contents of which are herein incorporated by reference.

### BACKGROUND OF THE INVENTION

The present invention relates to solar cells and methods and systems of making the same and, more particularly, a dye-sensitized solar cell that generates and stores energy and a method of making the same.

The advantages of solar energy are well understood by the general public due to the increased awareness of green energy. The working components for collecting solar energy are less known. At the heart of solar energy collection is a solar cell, or photovoltaic cell, which is an electronic device that converts the energy of light directly into electricity by the photovoltaic effect, which involves the absorption of solar photons. Conventional photovoltaics are largely based upon solid state materials, with silicon being the central element. However, the low absorbance of crystalline silicon requires the absorption layer to be a certain thickness for effective absorption of solar photons, making silicon-based solar cells expensive to make. Silicon can also produce toxic waste during solar cell production (which typically needs a clean room for manufacture).

Many scientists believe that an alternative technology, dye-sensitized solar cells (DSSC), is less expensive to fabricate and more environmentally friendly. DSSC is based upon the absorption and excited state properties of dye molecules that are bound to a titanium dioxide (TiO2) substrate. However, low efficiency is a major concern that prevents the widespread adoption of DSSC. Furthermore, the current cost to produce DSSC is not cheap and the life span of DSSC is not long. Currently existing DSSCs belong to the group of thin-film solar cells, wherein fabrication of the thin film requires complicated engineering processes, which in turn lowers efficiency and increases production costs.

Furthermore, the variation in sun radiation may lead to over-production of electricity from solar PV generators at one time, and lack of production to satisfy the energy demand at another time. As a result, solar PV systems demonstrate a low-level of reliability in power systems. However, an energy storage technology would play a significant role in increasing the reliability of solar power generation systems. As a result, in order to increase the reliability, all existing solar photovoltaic systems are relying on energy storage technology, i.e., converting the energy generated by the solar panel to the energy storage system (either battery array or super-capacitor), thus facing the energy lost at the conversion from the solar panel to the energy storage.

As can be seen, there is a need for a dye-sensitized solar cell that generates and stores energy, wherein the inherent photovoltaic absorber layer is fabricated, in part, through the application of an anodic paste along a transparent conductive substrate, resulting in an increased life span and a 50% to 150% increase in the efficiency compared to current thin-film DSSC.

### SUMMARY OF THE INVENTION

The present invention stores the energy generated from sun light directly to itself, thus reduces the conversion loss from the cell to the energy storage system, thereby further increasing efficiency.

The present invention embodies a method of fabricating a photovoltaic absorber layer through the application of an anodic paste along a transparent conductive substrate, wherein the anodic past is a mixture of dye, electrolyte, and TiO2 nanoparticle powder.

In one aspect of the present invention, a method of manufacturing a photovoltaic absorber layer includes applying an anodic paste to a transparent conductive substrate.

In another aspect of the present invention, the method of manufacturing a photovoltaic absorber layer includes wherein the anodic paste comprises a mixture of titanium dioxide (TiO2), acid, dyes, and electrolytes so that the anodic paste is spreadable along a surface of the transparent conductive substrate, wherein the anodic paste comprises a mixture of titanium dioxide (TiO2), acid, dyes, and electrolytes so that the anodic paste is spreadable along a surface of the transparent conductive substrate, wherein the TiO2 is in the form of a nanoparticle powder; further including sandwiching the anodic paste against a cathodic element; and depositing spacers along the anodic paste prior to interfacing with the cathodic element.

In yet another aspect of the present invention, the method of manufacturing a photovoltaic absorber layer, wherein the method comprises urging an anodic paste between a transparent conductive substrate and a cathodic element.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention, shown in use.

FIG. 2 is an exploded top perspective view of an exemplary embodiment of the present invention.

FIG. 3 is a flow chart 30 of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a method of fabricating a photovoltaic absorber layer through the application of an anodic paste along a surface of the transparent conductive substrate, wherein the applied surface is coupled to a cathodic element. The anodic paste comprises titanium dioxide nanoparticles in powder form mixed with light-absorbing dye(s) and electrolytic paste.

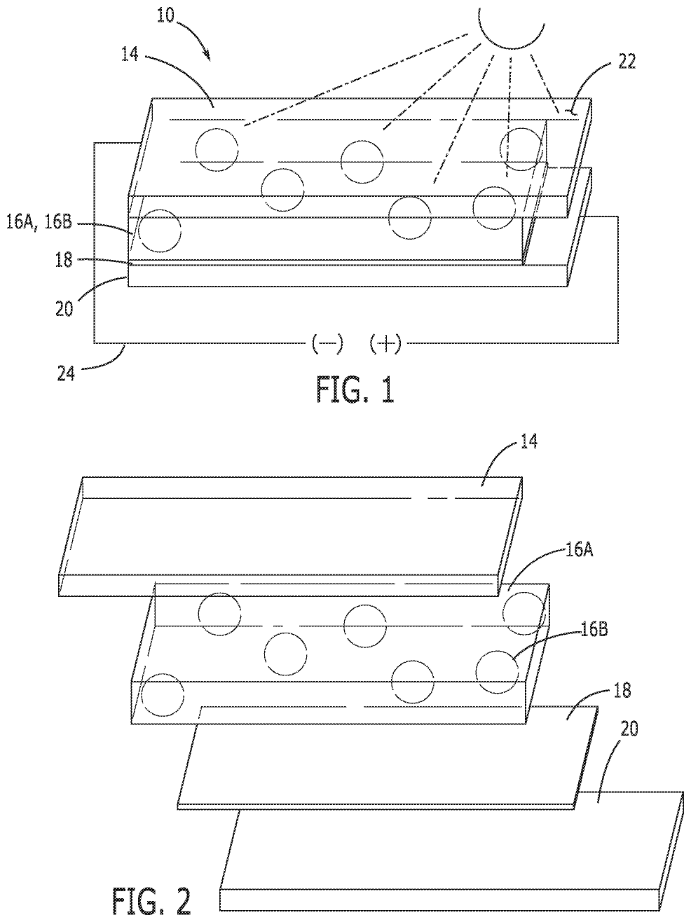

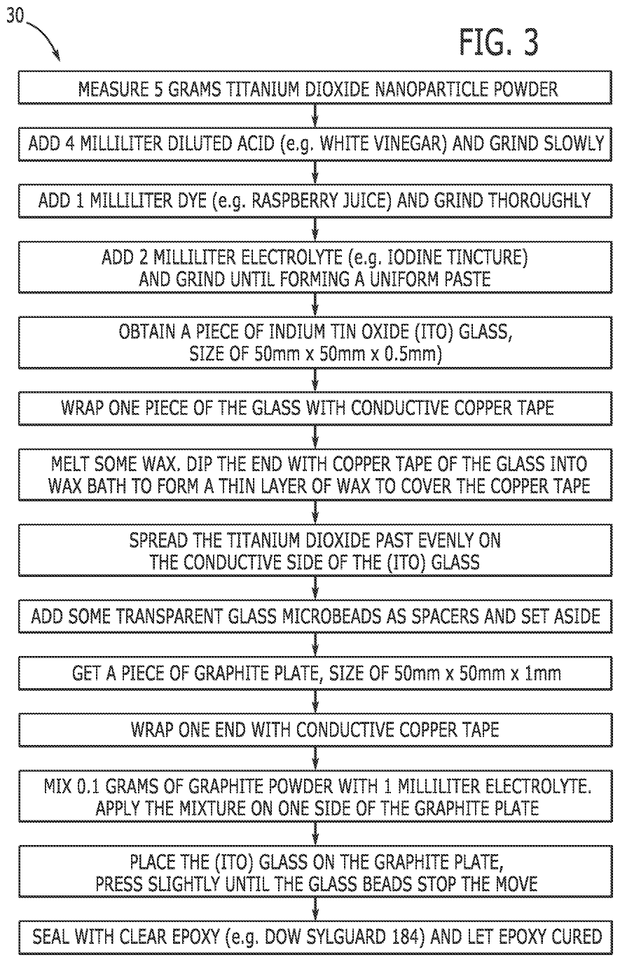

Referring now to FIGS. 1 through 3, the present invention includes a method of fabricating a thin film photovoltaic absorber layer solar cell 10. The method includes a procedure for producing an anodic element, a procedure for producing a cathodic element, and procedure for operatively associating the anodic and cathodic elements.

The procedure for producing the anodic element includes a process of forming an anodic paste 16A, a process for preparing a transparent conductive substrate 14 (e.g., ITO conductive glass), and simply evenly spreading or applying the anodic paste to the surface of the transparent conductive substrate 14 by any acceptable spreading tool, e.g., using a glass rod to roll over the surface to spread the paste evenly across, or simply using a spatula to spread the paste evenly. In one embodiment, the process of producing anodic (titanium dioxide) paste 16A may include the following steps: measuring five (5) grams titanium dioxide (TiO2) nanoparticle powder; adding four (1) milliliter diluted acid (e.g., white vinegar) and grinding slowly; then adding one (4) milliliter organic light-absorbing dye (e.g., raspberry juice) and again grinding thoroughly; adding two (2) milliliter electrolyte (e.g., Iodine tincture) and grind until a uniform anodic paste 16A is formed.

In one embodiment, the process for preparing a transparent conductive substrate 14 includes the following steps: obtaining a piece of Indium tin oxide (ITO) glass, size of 50 mm×50 mm×0.5 mm; wrapping one end of the glass with conductive copper tape; depositing a thin layer of wax to cover the copper tape (e.g., dipping the end with copper tape of the glass into a melted wax bath).

In one embodiment, the process for bonding or applying the anodic paste 16A to the transparent conductive substrate 14 includes the following steps: spreading the anodic paste evenly on the conductive side of the ITO glass, resulting in the anodic element; and then depositing a spacer 16B (e.g., some transparent glass microbeads) on the spread anodic paste 16A.

The procedure for producing the cathodic element may include wrapping one end of a substrate of graphite plate 20 (e.g., size of 50 mm×50 mm×1 mm) with conductive copper tape; and applying a mixture of graphite powder and electrolyte paste 18 (e.g., 0.1 grams of graphite powder with 1 milliliter electrolyte) one side of the graphite plate 20, resulting in one embodiment of the cathodic element.

The procedure for operatively associating the anodic and cathodic elements gently pressing the conductive side of the ITO glass (the anodic element) against the graphite plate/cathodic until the glass beads 16B stops the movement. Then bond the anodic and cathodic elements with clear epoxy seal 22 (e.g., Dow SYLGUARD™ 184) and let epoxy seal cure.

By following the above listed steps, a novel dye-sensitized solar cell unit is created. After epoxy cured, the DSSC unit could generate and store the electrical energy when light interacts with the anodic element. For instance, by way of an electrical conductor 24, the graphite side/cathodic element shall be connected to the positive terminal of a multimeter or electronic device, and the ITO glass side/anodic element shall be connected to the negative terminal of the multimeter or electronic device, whereby an electrical voltage and current would be observed. Additionally, the novel dye-sensitized solar cell unit could be used as a solar panel.

The coating on graphite plate 20 with graphite powder and electrolyte mixture 18 could be optional. The types of dyes, electrolytes, acid and the mixture ratio of titanium dioxide, acid, dyes, and electrolytes could be adjusted for better performance. The glass beads could be replaced with fiber optics, glass tubes, or other spacers. The sealant could be UV-cured epoxy, clear epoxy or a silicone elastomer, or the sealant could be printed on the ITO glass, add the spacer then pressure bonding to put anode and cathode together. The mixture of Titanium Dioxide, acid, dyes, and electrolytes could then be injected into the gap and completely sealed off.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of manufacturing a photovoltaic absorber layer, wherein the method comprises applying an anodic paste to a transparent conductive substrate.

2. The method of claim 1, wherein the anodic paste comprises a mixture of titanium dioxide (TiO2), acid, dyes, and electrolytes so that the anodic paste is spreadable along a surface of the transparent conductive substrate.

3. The method of claim 1, wherein the anodic paste comprises a mixture of titanium dioxide (TiO2), acid, dyes, and electrolytes so that the anodic paste is spreadable along a surface of the transparent conductive substrate.

4. The method of claim 3, wherein the TiO2 is in the form of a nanoparticle powder.

5. The method of claim 4, further comprising sandwiching the anodic paste against a cathodic element.

6. The method of claim 5, further comprising depositing spacers along the anodic paste prior to interfacing with the cathodic element.

7. A method of manufacturing a photovoltaic absorber layer, wherein the method comprises urging an anodic paste between a transparent conductive substrate and a cathodic element.
